(19) United States
(12) Patent Application Publication
(10) Pub. No.: US 2008/0112364 A1
(43) Pub. Date: May 15, 2008

(54) METHOD AND APPARATUS FOR PERFORMING HANDOVER IN WIRELESS NETWORK

(75) Inventors: Chang-Yeul Kwon, Yongin-si (KR); Jae-Min Lee, Suwon-si (KR); Guoping Fan, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/940,344

(22) Filed: Nov. 15, 2007

Related U.S. Application Data
(60) Provisional application No. 60/859,001, filed on Nov. 15, 2006.

(30) Foreign Application Priority Data
Jun. 27, 2007 (KR) 10-2007-0063780

(51) Int. Cl. H04Q 7/00

(52) U.S. Cl. 370/331

(57) ABSTRACT

A method and apparatus for performing a handover in high frequency wireless communications are provided. A device for performing a handover in a wireless network, includes a priority order list including a priority order for becoming a coordinator, a handover controller making a handover request to a selected device existing on the network based on the priority order, and a transceiver transmitting network information of the device performing the handover according to the handover request.

### CROSS-REFERENCE TO RELATED APPLICATION

This application claims priority from U.S. Provisional Application No. 60/859,001 filed on Nov. 15, 2006 in the United States Patent and Trademark Office, and Korean Patent Application No. 10-2007-0063780 filed on Jun. 27, 2007 in the Korean Intellectual Property Office, the disclosure of which is incorporated herein by reference in its entirety.

### BACKGROUND OF THE INVENTION

1. Field of the Invention

The present invention relates to wireless communication technology, and, more particularly, to a method and apparatus for performing a handover in high frequency wireless communications.

2. Description of the Related Art

As networks become wireless and the demand for large multimedia data transmission increases, there is a need for research on the most effective transmission method for wireless networks. In particular, the need for various home devices to wirelessly transmit high-quality video, such as digital video disk (DVD) images or high definition television (HDTV) images, is growing.

An IEEE 802.15.3c task group is developing a technological standard for transmitting large volumes of data over a wireless home network. The technological standard, which is called “millimeter wave (mmWave),” uses an electromagnetic wave having a millimeter wavelength (i.e., an electromagnetic wave having a frequency in the frequency band of 30-300 GHz) to transmit large volumes of data. This unlicensed frequency band has conventionally been used by communication service providers or for limited purposes, such as preventing vehicle collisions.

FIG. 1 is a diagram which compares frequency bands of the IEEE 802.11 series of standards and mmWave. Referring to FIG. 1, the IEEE 802.11b and IEEE 802.11g standard use a carrier frequency of 2.4 GHz and have a channel bandwidth of approximately 20 MHz. In addition, the IEEE 802.11a and IEEE 802.11n standards use a carrier frequency of 5 GHz and have a channel bandwidth of approximately 20 MHz. In contrast, mmWave uses a carrier frequency of 60 GHz and has a channel bandwidth of approximately 0.5-2.5 GHz. Therefore, it can be understood that mmWave has a far greater carrier frequency and channel bandwidth than the related art IEEE 802.11 series of standards. When a high-frequency signal (a millimeter wave) having a millimeter wavelength is used, a very high transmission rate of several Gbps can be achieved. Since the size of an antenna can also be reduced to less than 1.5 mm, a single chip including the antenna can be implemented. Furthermore, interference between devices can be reduced due to the very high attenuation ratio of the high-frequency signal in the air.

Specifically, a method of transmitting uncompressed audio or video data (hereinafter, referred to as uncompressed AV data) between wireless devices using the high bandwidth of a millimeter wave has recently been studied. Compressed AV data is generated after lossy compression processes including motion compensation, discrete cosine transform (DCT), quantization, and variable length coding (VLC) processes. In so doing, portions of the compressed AV data, to which human visual and auditory senses are less sensitive, are removed. In contrast, uncompressed AV data includes digital values indicating pixel components (for example, red (R), green (G) and blue (B) components).

A network coordinator (to be simply referred to as a coordinator hereinafter) is required for the network constituted by wireless devices transmitting or receiving data through high-frequency bands. In general, the coordinator performs initialization management of the network, management of nodes (wireless devices), bandwidth allocation, and so on. However, in a case of an abrupt shut down or coordinator incapability, the coordinator hands out its right(s) as the coordinator to another wireless device, which is commonly referred to as a handover.

FIG. 2 is a diagram illustrating the concept of a general handover process. A wireless network 10 includes a plurality of devices 11, 12, 13, and 15, which can communicate with one another. One of the plurality of devices 11, 12, 13, and 15 may take a role as a coordinator. For example, the device 15 is a device member of the wireless network 10 and is a coordinator as well. The coordinator 15 periodically transmits management frames, such as beacons, to the devices 11, 12, and 13, and receives network participation requests, bandwidth allocation requests, or the like, therefrom, and manages the network.

In the case where the coordinator 15 cannot properly function as a coordinator any longer (e.g., a power-off, a disconnection from the network, or the like occurs), the coordinator role is transferred to one of the devices 11, 12, and 13, e.g., the device 13, which is capable of performing the coordinator functions.

In order for the coordinator of the conventional wireless network system to transfer its coordinator role to another wireless device, it is necessary to find the optimum wireless device by comprehensively considering performance parameters of wireless devices existing on the wireless network. Then, the coordinator role is transferred to the optimum wireless device having the highest performance. Various performance parameters of the wireless devices include data security, the maximum number of wireless devices allowed to exist on the network, the maximum number of time slots allowed for allocation, the transmission power level, the maximum transfer rate, and so on.

Unlike in the conventional wireless network system, in the high frequency wireless network system in which uncompressed AV data is transmitted or received through a high frequency band, it may become a critical issue to transmit large volumes of data in a seamless, stable manner. Accordingly, it would be highly desirable to devise a handover algorithm adapted to such communication environments.

### SUMMARY OF THE INVENTION

An aspect of the present invention provides a handover method and apparatus of a coordinator in high frequency wireless communications, which can transmit large volumes of uncompressed AV data in a frequency band in the several gigabit (Gbits per second) range.

The above and other aspects of the present invention will be described in or be apparent from the following description of exemplary embodiments.

According to an aspect of the present invention, there is provided a device for performing a handover in a wireless network, the device including a priority order list including a priority order for becoming a coordinator, a handover controller making a handover request to one device selected from devices existing on the network based on the priority order, and a transceiver transmitting network information of the device performing the handover according to the handover request.

According to another aspect of the present invention, there is provided a method of performing a handover in a wireless network, the method including selecting at least one of the devices existing on the network based on a priority order list including a priority order for becoming a coordinator, making a handover request to the at least one selected device, and transmitting network information to the at least one selected device according to the handover request, wherein the priority order is determined according to criteria for determining whether the devices existing on the network are driven with sustained power and whether the devices existing on the network are positioned at fixed locations.

### BRIEF DESCRIPTION OF THE DRAWINGS

The above and other features and advantages of the present invention will become apparent by describing in detail exemplary embodiments thereof with reference to the attached drawings in which:

FIG. 1 is a diagram which compares frequency bands of the IEEE 802.11 series of standards and mmWave;

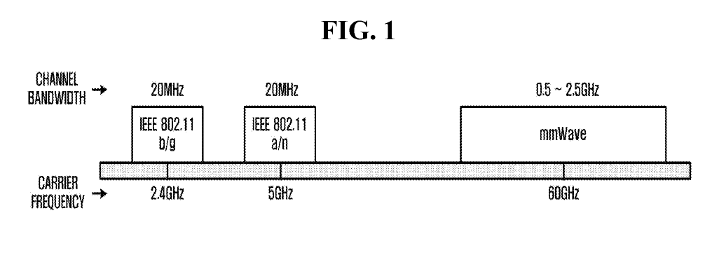

FIG. 2 is a diagram illustrating the concept of a general handover;

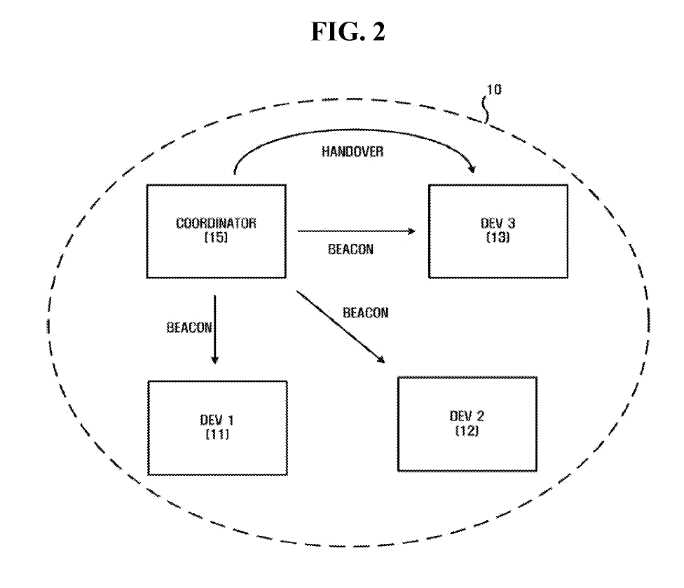

FIG. 3 shows the structure of an association-request frame according to an exemplary embodiment of the present invention;

FIG. 4 is a flow diagram of a scheduled handover process according to an exemplary embodiment of the present invention;

FIG. 5 is a flow diagram of an unscheduled handover process according to an exemplary embodiment of the present invention; and

FIG. 6 is a block diagram of a wireless device according to an exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Reference will now be made in detail to the present exemplary embodiments of the invention which are illustrated in the accompanying drawings.

The present invention is directed to a handover method of a network coordinator in high frequency wireless communication. To achieve the present invention, in the following description, criteria of determining a device priority order and various triggering reasons causing a handover of a coordinator will first be defined and a handover process will then be described in detail.

Priority Order List

In the wireless PAN standard in compliance with the IEEE 802.15.3 specification, the optimum coordinator is determined by comprehensively considering various functions of devices existing on the network in an integrated manner. However, the conventional criteria are not suitably applied to a network environment in which large volumes of data are transmitted through a high-frequency band. Instead, the overall criteria that depend on device characteristics are required. Thus, in the coordinator handover according to the present invention, the priority for becoming a coordinator is given according to the priority order. In order for a device to become a coordinator, the following requirements should be met. First, the device must be in a powered-on state. Then, the device should have coordinator capability.

A coordinator is determined at an initial stage of establishing the network in accordance with the priority order. However, the initially determined coordinator may be shut down at a later time, or the coordinator may become disconnected from the network. Alternatively, another candidate device may be determined as a new coordinator in accordance with the priority order. Further, a device having a higher priority level than the existing coordinator may newly join the network. In such a case, the new participant device becomes a coordinator.

In more detail, in transmitting/receiving large volumes of AV data, a device capable of functioning as a source device has a higher priority level than the other devices. The coordinator allocates data transmission periods, i.e., time slots, to devices existing on the network upon receipt of time slot allocation requests. The time slots may not be allocated to the devices according to network conditions, and, even if allocated, the number of time slots allocated to the devices may not be sufficient. Therefore, if a source device capable of transmitting large volumes of AV data becomes a coordinator, a sufficient number of time slots can be allocated to the source device, thereby transmitting large volumes of AV data in a seamless, stable manner.

TABLE 1
Criteria for determining the priority order

| Criteria | Description |
|---|---|
| Power source | Devices driven with AC power (i.e., power in a |
| | sustained period of time) have higher priority levels |
| | than devices driven with power from batteries. |
| Mobility | Devices positioned at fixed locations have higher |
| | priority levels than portable devices or mobile |
| | devices. |

Table 2 shows an exemplary priority order list prepared based on the criteria shown in Table 1. The priority order list includes a top group, a primary group and a non-primary group.

TABLE 2

| Priority Order | Type of Device |
|---|---|
| Top group | Digital TV |
| Primary group | Set-top box/PVR |
| | DVD/BD/HD-DVD player |
| | DVD/BD/HD-DVD recorder |
| | A/V receiver |
| | PC |
| | Beam projector |
| Non-primary group | Game console |
| | Digital camcorder |
| | Digital camera |
| | PDA |
| | PMP |
| | MP3 player |
| | Mobile phone |
| | Others |

In particular, as defined in Table 1, the digital TV classified as the top group has top priority and has the following characteristics over the other devices belonging to the primary group.

First, the digital TV generally has a longer active time than the other devices. For example, when a DVD recorder, a DVD player, or a set-top box is turned on, the digital TV has already been in the powered-on state, in general. Thus, the digital TV almost never encounters a handoff.

Second, a user has easy access to the network through a screen of the digital TV. For example, the user may take advantage of an interactive function of the digital TV, e.g., VOD (Video On Demand) through a screen of the digital TV. Furthermore, when a new device is added to the network, the user has only to enter a password for ensuring security through the digital TV.

Third, the digital TV is generally placed at a central location of an entertainment area.

Fourth, the digital TV, which is relatively bulky and heavy, is not likely to be moved to another location, once placed at a fixed position.

For the foregoing reasons, the digital TV is more suitable to be a coordinator than the other devices belonging to the primary group. Accordingly, the digital TV preferably belongs to the top group in the priority order list.

Determination as to whether a handover has occurred in special circumstances and selecting a device which will transfer a role as a coordinator are made according to the priority order list.

It is assumed that to a digital TV, a set-top box, and a DVD recorder exist on a current network and both the digital TV and the DVD recorder, except for the set-top box, have coordinator capability, for example. In this case, the digital TV functions as a coordinator on the current network according to the priority order list shown in Table 2. However, when the digital TV disconnects from the network, any device belonging to the primary group can hand over the coordinator capability. In other words, there is no difference in the priority order between devices belonging to the peer group.

Accordingly, when the digital TV is powered-on in a state in which the set-top box functions as a coordinator, the set-top box performs a handover to the digital TV. However, when the PC, which belongs to the peer group as the set-top box, is powered-on, the set-top box does not perform a handover to the PC.

As described above, according to an embodiment of the present invention, a handover is not performed within the peer group including devices having the same levels of priority. According to alternative embodiments of the present invention, however, a handover may be triggered between devices belonging to the peer group by specified criteria. The specified criteria may include hardware performance such as processor performance, memory capacity, transmission power level, data rate, and so on.

In order for a coordinator to select a device as a back-up coordinator, i.e., a device for transferring the coordinator role, it is necessary to have information about the device. In joining a network, every device transmits an association-request frame to a coordinator while providing its own information to the coordinator. The priority order list is recorded based on the association-request frame which is transmitted by the devices.

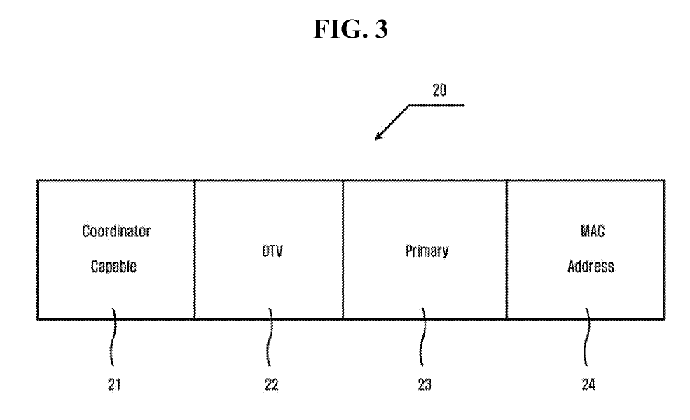

FIG. 3 shows a structure of an association-request frame 20 according to an embodiment of the present invention.

A Coordinator Capable field 21 is a field indicating whether a device joining the network is capable of functioning as a coordinator. When a device is not capable of functioning as a coordinator, even if it has a high priority level, it cannot transfer the handover. Thus, the field 21 is checked first irrespective of the priority order of the device.

A DTV field 22 is a field indicating whether a device joining the network is a digital TV or not. For example, when a value of the DTV field 22 is read as 1, a corresponding device is a digital TV, and when a value of the DTV field 22 is read as 0, the corresponding device is not a digital TV.

A Primary field 23 is a field indicating whether a device joining the network belongs to a primary group. For example, when a value of the Primary field 23 is 1, the corresponding device belongs to a primary group, and when a value of the Primary field 23 is 0, the corresponding device belongs to a non-primary group. Accordingly, the digital TV and the devices belonging to the primary group and the non-primary group have combinations of “10”, “01” and “00” in the DTV field 22 and the Primary field 23.

A MAC Address field 24 is a field defining a MAC address of a device joining the network. Since the MAC address is a unique address of the corresponding device, the coordinator can allocate an identifier to the device, which can be generally used throughout the network, that is, a device ID.

Although not shown, an association-request frame 20 may further include an index number field having an index number of a corresponding frame recorded therein, a length field, and so on.

Handover Trigger

A handover of a coordinator may be triggered for various reasons, for example, an abrupt power-off of a current coordinator, an expected shut down of a current coordinator, a connection error between a current coordinator and other devices existing on the network, association of a new device having a higher priority level to the network, and so on.

Handover Process

According to the present invention, a handover process may be divided into a scheduled handover and an unscheduled handover.

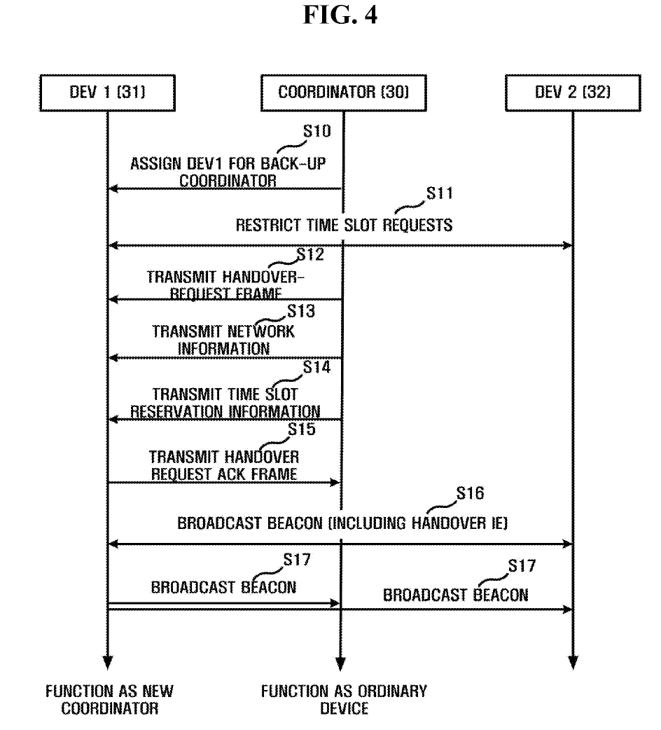

FIG. 4 is a flow diagram of a scheduled handover process according to an embodiment of the present invention.

The scheduled handover takes place when a coordinator gives up functioning as a coordinator, or a coordinator-capable device with a higher priority level joins the network.

First, a coordinator 30 assigns a device having a higher priority level of devices 31 and 32 existing on the network, which will be briefly referred to as “DEV1” 31 hereinafter, for a back-up coordinator based on a priority order list in operation S10.

In a case where a handover process is scheduled, the coordinator 30 restricts time slot requests from the devices 31 and 32 in operation S11. In detail, upon receipt of the time slot requests from the devices 31 and 32, the coordinator 30 notifies the devices 31 and 32 of rejections in response to the time slot requests.

Next, the coordinator 30 selects a back-up coordinator based on a priority order list. If DEV1 31 is selected as the back-up coordinator, the coordinator 30 transmits a handover-request frame to DEV1 31 in operation S12. Then, the coordinator 30 transmits network information that it possesses to DEV1 31. In detail, the coordinator 30 transmits information about devices existing on the network to DEV1 31 in operation S13 and transmits information about time slots reserved so far (i.e., time slot reservation information) to DEV1 31 in operation S14.

DEV1 31 having received the handover-request frame can transmit a handover request acknowledge (ACK) frame within a predetermined time-out period in operation S15. Here, the handover request ACK frame includes acceptance of or rejection for the request for the handover. If the coordinator 30 cannot receive the handover request ACK frame within the predetermined time-out period, the request for the handover is considered as being rejected.

If DEV1 31 accepts the request for the handover, the coordinator 30 broadcasts a beacon containing a handover information element (IE) to the devices 31 and 32 on the network. Based on the beacon, the devices 31 and 32 on the network know that DEV1 31 is the new coordinator.

Thereafter, DEV1 31 operates as a new coordinator, and the coordinator 30 operates as an ordinary device, i.e., as a non-coordinator device, like DEV2 32.

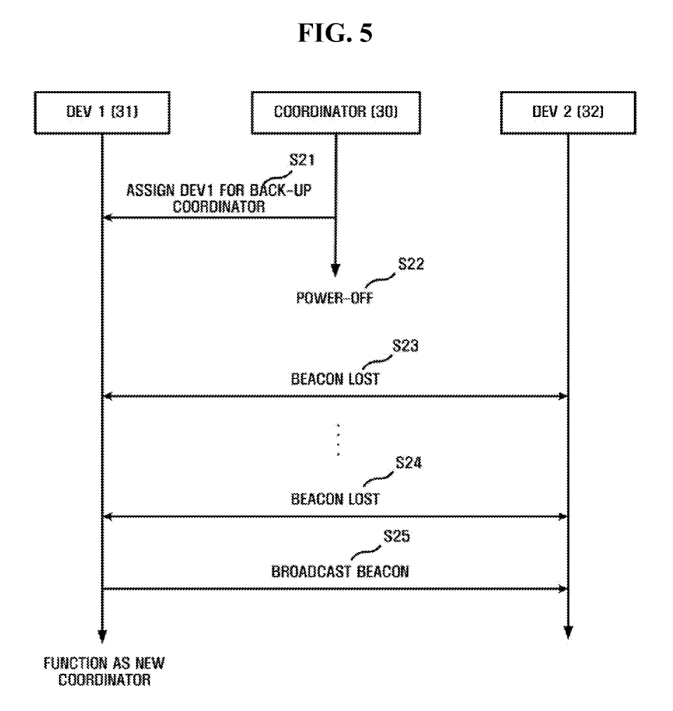

FIG. 5 is a flow diagram of an unscheduled handover process according to an embodiment of the present invention.

While the coordinator 30 performs a scheduled handover process, an unscheduled handover process may be performed in the case where the coordinator 30 is unexpectedly unable to function as a coordinator.

In such a case, the coordinator 30 assigns one of the devices 31 and 32 on the network, which has a higher priority level, i.e., DEV1 31, as a back-up coordinator based on a priority order list, in operation S21. Thereafter, the coordinator 30 may be abruptly in a power-off state for some reason in operation S22.

Then, the devices 31 and 32, waiting for a beacon broadcast for a predetermined period, repeatedly do not receive the beacon in operations S23 and S24. If DEV1 31, assigned as a back-up coordinator, loses the beacon continuously more than a predetermined number of times, it is considered that the coordinator 30 cannot function as a coordinator any longer and DEV1 31, which has been assigned as a back-up coordinator, takes the role of the coordinator.

Thereafter, DEV1 31 periodically broadcasts a beacon to the other device 32 on the network to then start to function as a new coordinator (S25). Here, DEV1 31 as a new coordinator can know the state of the other device 32 by checking traffic during a dynamic channel time block (CTB).

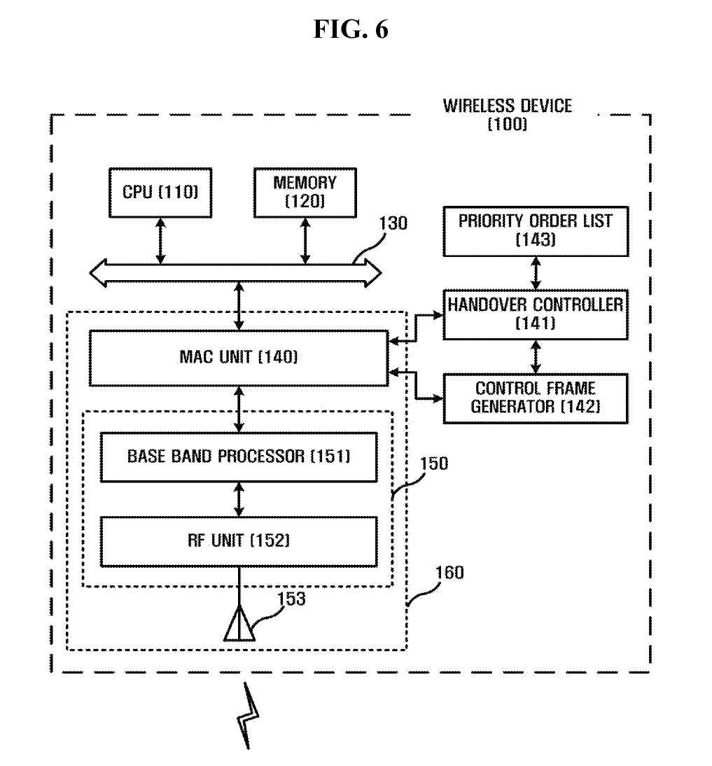

FIG. 6 is a block diagram of a wireless device 100 according to an embodiment of the present invention.

The wireless device 100 has capability of functioning as a network coordinator, that is, coordinator capability. Thus, the wireless device 100 may become a coordinator or an ordinary wireless device which does not function as a coordinator according to circumstances.

The wireless device 100 may include a CPU 110, a memory 120, a MAC unit 140, a PHY unit 150, a handover controller 141, a control frame generator 142, and an antenna 153. Specifically, the MAC unit 140, the PHY unit 150 and the antenna 153 may be collectively defined as a transceiver 160.

The CPU 110 controls other components connected to a bus 130, and is responsible for procedures in communication layers above a MAC layer. Thus, the CPU 110 processes data supplied from the MAC unit 140 as received MAC Service Data Unit (MSDU) or generates uncompressed AV data as transmitted MSDU to supply the same to the MAC unit 140.

The memory 120 stores the processed reception MSDU data or temporarily stores the generated transmission MSDU. The memory 120 can be implemented by a non-volatile memory such as read-only memory (ROM), programmable read-only memory (PROM), erasable programmable read only memory (EPROM), electrically erasable programmable read only memory (EEPROM), a volatile memory such as a random access memory (RAM) or a storage medium, such as a hard disk drive, or other suitable memory, but the invention is not limited in this regard.

The MAC unit 140 adds a MAC header to the uncompressed AV data supplied from the CPU 110 or a control frame generated by the control frame generator 142 to then generate the MAC Protocol Data Unit (MPDU). The generated MPDU is transmitted through the PHY unit 150.

The PHY unit 150 adds a signal field and a preamble to the MPDU supplied from the MAC unit 140 to generate a PLCP Protocol Data Unit (PPDU). The generated PPDU, i.e., a data frame, is converted into a RF signal to then be transmitted through the antenna 153. The PHY unit 150 is divided into a base band processor 151 processing a base band signal, and a RF (radio frequency) unit 152 generating a RF signal from the processed base band signal and transmitting the RF signal into the air through the antenna 153.

In more detail, the base band processor 151 performs frame formatting, channel coding, and so on. The RF unit 152 performs analog wave amplification, analog-to-digital conversion, modulation, and so on.

The control frame generator 142 generates control frames for controlling communications on the network and supplies the generated control frames to the MAC unit 140. The control frames may include a beacon frame periodically broadcast over the network, a frame responding to a time slot request, a handover-request frame, a frame for transmitting network information to a back-up coordinator, and so on.

The priority order list 143 includes a priority order recorded according to the type of device, as listed in Table 2. The priority order list 143 may be stored in the memory 120.

The handover controller 141 selects one among other wireless devices belonging to the network as a back-up coordinator based on the priority order list, and when specified conditions are met, a hand over request is sent to the selected wireless device. When the handover request is made, the handover controller 141 controls the control frame generator 142 to generate a handover-request frame.

In addition, after receiving the handover request, the handover controller 141 transmits the network information possessed by the wireless device 100 to the selected wireless device through the transceiver 160. The network information includes device information about other wireless devices existing on the network, previously requested time slot reservation information, and so on.

Thereafter, the handover controller 141 receives a response to the handover request from the selected wireless device through the transceiver 160. If the response indicates that the handover request is accepted, meaning that a normal handover is performed, the handover controller 141 broadcasts a beacon frame containing a handover IE over the network. However, if the handover request is rejected, a handover may be performed again on another target wireless device having a next priority level based on the priority order.

The logic blocks described with reference to the embodiments of the invention shown in FIG. 6 may be realized or performed using a general purpose processor designed to perform the functions described in this specification, a digital signal processor (DSP), an application specific integrated circuit (ASIC), a field programmable gate array (FPGA), another programmable logic unit, a discrete gate or a transistor logic unit, discrete hardware components, or a combination thereof. The general purpose processor may be a microprocessor. However, the general purpose processor may be, selectively, an arbitrary conventional processor, a controller, a microcontroller, or a state machine. Further, the general purpose processor may be realized by a combination of computing devices, for example, a combination of a DSP and a microprocessor, a plurality of microprocessors, and/or at least one microprocessor related to a DSP core, etc.

According to aspects of the present invention, a handover of a coordinator can be efficiently performed based on a predetermined priority order in a high-frequency wireless network.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A device for performing a handover in a wireless network, the device comprising:
a storage module which stores a priority order list including a priority order for becoming a coordinator;
a handover controller which generates a handover request to one selected device existing on the network based on the priority order; and
a transceiver which transmits network information of the device performing the handover according to the handover request.

2. The device of claim 1, wherein an association-request frame which is transmitted by devices existing on the network when the devices join the network comprises a field which indicates the priority order of each of the devices for becoming the coordinator.

3. The device of claim 1, wherein the priority order list includes a digital TV which has a top priority in the priority order list;
a primary group which includes a set-top box, a Personal Video Recorder) (PVR), a DVD player, a Blue-ray Disc (BD) player, a High Definition-DVD (HD-DVD) player, a DVD recorder, a BD recorder, a HD-DVD recorder, an A/V receiver, a personal computer (PC), and a beam projector; and
a non-primary group which includes a game console, a digital camcorder, a digital camera, a Personal Digital Assistant (PDA), a Portable Multimedia Player (PMP), an MP3 player, and a mobile phone.

4. The device of claim 1, wherein the network includes a network which uses a bandwidth of millimeter wavelength.

5. The device of claim 1, wherein the devices on the network transmit or receive uncompressed audio/video data.

6. A method of performing a handover in a wireless network comprising devices, the method comprising:
selecting at least one of the devices existing on the network based on a priority order list including a priority order for becoming a coordinator;
making a handover request to the at least one selected device; and
transmitting network information to the at least one selected device according to the handover request.

7. The method of claim 6, wherein an association-request frame which is transmitted by devices existing on the network when the devices join the network comprises a field which indicates the priority order of each of the devices for becoming the coordinator.

8. The method of claim 6, wherein the priority order list includes a digital TV which has a top priority in the priority order list;
a primary group which includes a set-top box, a Personal Video Recorder) (PVR), a DVD player, a Blue-ray Disc (BD) player, a High Definition-DVD (HD-DVD) player, a DVD recorder, a BD recorder, a HD-DVD recorder, an A/V receiver, a personal computer (PC), and a beam projector; and
a non-primary group which includes a game console, a digital camcorder, a digital camera, a Personal Digital Assistant (PDA), a Portable Multimedia Player (PMP), an MP3 player, and a mobile phone.
